(19) United States
(12) Patent Application Publication
(10) Pub. No.: US 2003/0144947 A1
(43) Pub. Date: Jul. 31, 2003

(54) Computer-based system for hedging and pricing customized basket exchange swaps

(76) Inventor: Richard C. Payne, Mississauga (CA)

Correspondence Address: Robert P. Simpson, Esq., Simpson & Simpson, PLLC, 5555 Main Street, Williamsville, NY, 14221-5406, US

(21) Appl. No.: 10/201,509

(22) Filed: Jul. 23, 2002

Related U.S. Application Data
(60) Provisional application No. 60/309,900, filed on Aug. 3, 2001.

(51) Int. Cl. G06F 17/60

(52) U.S. Cl. 705/37

(57) ABSTRACT

A computer-based system for hedging and pricing customized basket exchange swaps including a computer-based method for efficiently determining an asset mix to hedge a customized basket exchange swap with a specified term, notional amount, reference index, and custom index, and an estimated tracking error for the asset mix, comprising the steps of, updating a matrix factorization to reflect current financial market data, calculating an objective vector based on current composition of the custom index, determining a correlation coefficient and the asset mix from the matrix factorization and the objective vector, and, calculating an estimated tracking error from the correlation coefficient. The system also includes a computer-based method for determining a price to charge for entering into a customized basket exchange swap, based on an estimated tracking error of an asset mix to hedge the customized basket exchange swap, and a capital requirement and a target rate of return for a counterparty to the customized basket exchange swap. The system also includes an article of manufacture comprising a customized basket exchange swap with a specified term, notional amount, reference index, and custom index operatively arranged to allow an index administrator designated by a counterparty to such customized basket exchange swap to specify a composition of the custom index at a start of the term and changes to the custom index during the term, while guaranteeing that a value of the customized basket exchange swap at an end of the term will equal the notional amount times the difference in the growth of the reference and custom indices.

### CROSS REFERENCE TO RELATED APPLICATIONS

This application claims the benefit under 35 USC §119(e) of U.S. Provisional Patent Application Serial No. 60/309,900 filed Aug. 3, 9001.

### REFERENCE TO COMPUTER PROGRAM LISTING APPENDIX

The present application includes a computer program listing appendix on compact disc Two duplicate compact discs are provided herewith. Each compact disc contains ASCII text files of the computer program listing as follows:

| | |
|---|---|
| Filename: | ATREG1 DPR txt |
| Size | 15 KB |
| Date Created: | Jul. 19, 2002 |
| Filename: | DCAT1.IJS.txt |
| Size: | 10 KB |
| Date Created: | Jul. 19, 2002 |

The computer program listing appendix is hereby expressly incorporated by reference in the present application.

### FIELD OF THE INVENTION

The present invention relates generally to financial products, more specifically to computer-based systems for hedging and pricing financial products, and, even more particularly, to hedging and pricing a customized basket exchange swap.

### BACKGROUND OF THE INVENTION

Many individuals, corporations, and trusts face the problem of matching assets and liabilities. For example, a corporation may have liabilities where the amount of the liability is linked to the price of one or more publicly-traded securities If the corporation wants to eliminate fluctuations in its balance sheet due to fluctuations in the security price, the simplest strategy is to invest in the security (which we refer to as the “target asset”) directly in an amount equal to the amount of the liability.

Since the value of the target asset and the liability will then fluctuate in tandem, the capital of the corporation (equal to its assets minus its liabilities) will remain constant, so that the balance sheet of the corporation has been insulated from the fluctuations. We refer to an individual, corporation, or trust seeking to perform such matching, or seeking simply to realize the returns characteristic of the target asset, as an investor.

In some cases an investor may be unwilling or unable to hold the target asset directly because of expense or regulatory constraints. For example

A corporation may be reluctant to hold shares of an actively-managed mutual fund directly because income distributions and short-term capital gains distributions will be taxable to it at unpredictable times in the future;

A life-insurance company may be unable to invest the assets of one of its separate accounts backing a variable annuity or variable life policy in shares of a publicly-available mutual fund because of the tax effects of such an investment under 1.817-5(h) of the Internal Revenue Code; or

An investor may not wish to hold shares in many different equity mutual funds because of the likelihood that such a portfolio will in aggregate underperform a broad market index such as the S&P 500 by approximately the amount of the investment management fees

Such problems could be alleviated by using a new financial instrument, which we name the “customized basket exchange swap”. Such an instrument has the following main characteristics

It has a defined term, notional amount, reference index, and custom index;

The reference index can be a published index (e.g., the Nasdaq 100) or the actual realized growth in a particular pool of assets, such as a particular S&P 500 index fund;

The custom index is defined as a weighted average of asset values for a specific set of assets, where the universe from which the assets can be drawn and any limitations on the weights are mutually agreed by the counterparties;

One of the counterparties designates an index administrator, who determines the initial set of assets and the weights for the custom index and may change both of these during the term, once again within any limits agreed by the counterparties; and

At the end of the term, one of the counterparties pays the other the notional amount times the difference between the growth in the reference index and the growth in the custom index.

However, in order that a market for this type of instrument develop, there must be a practical method to hedge it, and to charge a price for it, based on an analysis of expected transaction costs, tracking errors, and capital requirements, such that two counterparties will enter into the agreement voluntarily.

For example, in the case where the target asset is composed of an aggregate of, e.g., hundreds of different securities, it may not be practical to trade each security because of transaction costs. In such a case, it might be more effective to hedge the customized basket exchange swap using exchange-traded funds (ETF's) corresponding to broad sectors of the market.

The immediate problem posed, then, is to find out which hedging assets in which amounts will hedge the target asset effectively. In order to be useful to an asset manager, this calculation must:

be timely (i.e., the timescale for the calculation cannot be much longer than the timescale over which target asset and hedging asset prices fluctuate);

reflect the most recent changes to the custom index made by the index administrator,

reflect up-to-date target asset and hedging asset prices; and

reflect the most current financial market information with respect to correlations within and between market sectors and between the target asset and the hedging assets.

Additionally, such a hedging approach leads to the possibility of tracking error, since a portfolio based on broad sector breakdowns will in general have a different return than an arbitrary basket of securities. An estimate of the expected tracking error associated with a given mix of hedging assets is required to make an intelligent tradeoff between expected tracking errors and transaction costs.

The problem of regulatory capital requirements for the counterparties to the swap also requires attention. The appropriate level of capital is a key component in determining the price at which two counterparties will willingly enter into the swap, since achieving a target return on regulatory capital is a requirement of financial institutions.

Historically, financial regulators have set capital requirements for financial products using a simple factor-based formula approach. Banks have been required to set aside capital equal to 8% of the amount loaned when making loans to industrial companies, for example

However, regulators have recently become increasingly likely to set capital requirements using a more sophisticated statistical approach in which the amount of capital set aside is equal to the magnitude of the potential loss, often at the 95^{th} percentile of some assumed loss distribution. Such an approach is usually referred to as a value-at-risk (VAR) methodology.

Thus adopting the more general hedging approach leads to a triple problem: the determination of an appropriate set of hedging assets, the determination of the likely magnitude of tracking errors, and the determination of the appropriate level of capital to be held by a counterparty assuming a VAR methodology.

As a result, there is a need for a computer-based method for determining an asset mix to hedge a customized basket exchange swap and a price to charge for entering into such a swap based on the estimated tracking error for the asset mix, and the capital requirements and target rate of return for a counterparty to such a swap

### SUMMARY OF THE INVENTION

The present invention generally comprises a computer-based method for determining an asset mix to hedge a customized basket exchange swap and a price to charge for entering into such a swap based on estimated tracking error, capital requirements, and target rate of return

The system includes a computer-based method for efficiently determining an asset mix to hedge a customized basket exchange swap with a specified term, notional amount, reference index, and custom index, and an estimated tracking error for the asset mix, comprising the steps of, updating a matrix factorization to reflect current financial market data, calculating an objective vector based on current composition of the custom index, determining a correlation coefficient and the asset mix from the matrix factorization and the objective vector, and, calculating an estimated tracking error from the correlation coefficient The system also includes a computer-based method for determining a price to charge for entering into a customized basket exchange swap, based on an estimated tracking error of an asset mix to hedge the, customized basket exchange swap, and a capital requirement and a target rate of return for a counterparty to the customized basket exchange swap. The system also includes an article of manufacture comprising a customized basket exchange swap with a specified term, notional amount, reference index, and custom index operatively arranged to allow an index administrator designated by a counterparty to such customized basket exchange swap to specify a composition of the custom index at a start of the term and changes to the custom index during the term, while guaranteeing that a value of the customized basket exchange swap at an end of the term will equal the notional amount times the difference in the growth of the reference and custom indices.

### DETAILED DESCRIPTION OF THE PREFERRED EMBODIMENT

Asset/liability management for variable deferred income plans (“mirror 401(k)s”) provides a tremendous sales opportunity for carriers and distributors. The quarterly corporate earnings mismatch that may occur in these plans is an impediment to their expansion and more widespread adoption. A method of reducing or eliminating this mismatch could lead to greatly increased sales

The “perfect solution” for this market would be a life insurance policy for which policy returns exactly tracked the returns of a specified basket of retail mutual funds or 401(k) funds selected by plan participants This would generate a dual benefit greater investment choice for plan participants and reduction in earnings volatility for the client company.

The present invention relates to a Variable Universal Life (VUL) or other investment product using a customized basket exchange swap, referred to herein as DCAT (Deferred Compensation Asset Tracking). This patent describes the product design, pricing, hedging, and compliance issues related to the product.

Terminology and Simplifying Assumptions

The term “client” is used to mean the client company, and “participant” means one of the employees participating in the client's variable deferred income plan The basket of assets selected by the participants and to be replicated is referred to as the “notional asset”.

Correlated Index Example

The simplest case is to forget about insurance entirely and just think about tracking one equity index using another, imperfectly correlated one with the same volatility This gives some insight into the more complicated cases

A good real-life example of two correlated indices is provided by the Russell 2000 Index and the Wilshire Smallcap Index—they are 98% correlated, but not exactly the same. How can we estimate the tracking error (basis risk) of using one as a proxy for the other? One way is to price a cash-settled European exchange option, first described by William Margrabe in 1978, which allows the holder (but doesn't force the holder) to exchange the returns on one asset for the returns on another at the end of a specified period of time.

For example, with an interest rate of 4%, volatility of 25%, no dividends, and time to expiry of three months (=0.25 years), the price of an option to exchange 100 units of index 1 for 100 units of index 2 at expiry, both indices assumed to be the same at the start of the period, depends on the correlation between the indices as follows:

| Correlation | Exchange Option Cost |
|---|---|
| 0.85 | 2.73 |
| 0.90 | 2.23 |
| 0.95 | 1.58 |
| 0.97 | 1.22 |

These results correspond to a one-sided quarterly performance guarantee (i.e., you can invest in the Russell 2000 and if the Wilshire Smalicap Index outperforms then your account will be topped up). They quantify what was probably intuitively obvious anyway: for reasonable correlation levels, a one-sided performance guarantee is too expensive to offer. Even with 97% correlation the annual cost is about 500 bp

The results also suggest how a carrier could track a specified notional asset using a separate account, rather than providing a one-sided guarantee. At the beginning of the period, the separate account buys the index and an index-to-notional exchange option, and sells a notional-to-index exchange option. Considerable simplification occurs if the counterparty for both of these options is the same.

At expiry, if the notional asset has outperformed, the separate account captures its excess return, matching the notional asset return If the index has outperformed, the counterparty captures the excess return from the separate account, so that once again the separate account matches the notional asset return. In this simple case, the separate account has financed the downside risk by selling off the upside excess return

Mutual Fund Basket Example

Basket Exchange Option

More realistically, the notional asset is probably not an index fund, since it is easy to track in the first place, but instead a basket of actively-managed mutual funds available in the client company's 401(k) plan. This has two main differences from the previous case: the correlation with an index will likely be lower, and the fund basket will typically have a performance disadvantage on an expected value basis compared with an index fund because of its higher management fees and administrative expense deductions

A short-term option on a basket of correlated assets is not exactly the same as an option on an index, but the approximation will be fairly good for typical large-cap equity mutual funds For convenience, we can refer to this type of option as a “basket exchange option”.

Assume that the carrier can invest in an index fund with annual expenses of 35 bp and is trying to track a fund basket with annual expenses of 65 bp It seems clear that in the absence of transaction costs, the carrier ought to be able to pick up 30 bp per year We can show this by recomputing the table above for two basket exchange options, one to switch from the index fund to the basket and one to switch the other way

| | Index to | Basket to | |
|---|---|---|---|
| | Basket Option | Index Option | Quarterly |
| Correlation | Cost | Cost | Difference |
| 0.85 | 2.69 | 2.76 | 0.07 |
| 0.90 | 2.19 | 2.26 | 0.07 |
| 0.95 | 1.54 | 1.61 | 0.07 |
| 0.97 | 1.18 | 1.26 | 0.08 |

The annualized expense differential of 30 bp between the index fund and the fund basket can be captured independently of the degree of correlation. This differential will at least partially offset the transaction costs of hedging the basket exchange options.

Passport Basket Exchange Option

Although it would be possible to structure new variable deferred income plans to allow participant allocation changes only once per quarter, this might not fit well with existing plans and procedures. Ideally, the client would like the allocation mix to be updated daily based on participant choices.

The resulting option could be described as a “passport basket exchange option”, since it allows the underlying asset mix to be updated by the option holder during the option term, in common with the passport option described by Hyer, Lipton-Lifschitz, and Pugachevsky in 1997.

Although the pricing problem for this option in full generality is difficult, substantial simplifications occur in this case because the VUL separate account or other investment account always buys and shorts the options in pairs, effectively using them to construct a swap. We refer to such a pair as a “passport basket exchange swap” for the remainder of the patent.

VUL and Rider Design—Regulatory Issues

Key Securities Law and Tax Design Issues

Although the SEC and IRS have not issued rulings on the precise benefit structure we describe here, it makes sense to examine the closest precedents and proceed by analogy.

The SEC Staff No-Action letter to the H.E.B. Investment and Retirement Plan (May 18, 2001) deals with the conditions that 401(k) plans allowing participant direction of contributions must follow for the plan to be treated as a qualified purchaser under 3(c)(7) of the 1940 Act. The outcome the plan was trying to avoid, of course, was the SEC finding the plan participants to be the investors in unregistered securities and in an unregistered investment company.

One of the representations made by the plan trustees, on which the SEC Staff presumably relied, was as follows, slightly paraphrased:

A plan participant's discretion is limited to allocating his or her account among a number of generic investment options; the decision to invest in a particular investment is solely within the discretion of a plan fiduciary.

Although review by carrier securities counsel is advisable, it seems that a private placement VUL would fit into this analysis best if the participants could choose only between broadly-defined investment alternatives, and not specific funds. The implication is that it may be better to use a registered product for this application.

Even though a registered product will likely be used, client-specific unit values are still required, because the unit value that tracks participant balances for one client will not track it for another. One way to address this is as follows:

Set up a series of divisions of the separate account. Each division is registered under the 40 Act, each with its own unit value, and each holding a passport basket exchange swap. Each client gets its own division of the separate account; and

Attach a “matching rider” to the policy, taking any rider charges from a general account bucket. The matching rider handles the mechanics of allowing the client to specify the notional assets being tracked, within whatever limits the carrier sets, and guaranteeing the result each quarter, even though the investment results are achieved inside the separate account division.

This seems to be the simplest workable structure: the obvious alternatives (such as a “matching rider” functioning as a swap rather than a guarantee) tend to raise more state law, securities law, or tax law issues.

Clearly, the use of client-specific separate accounts raises potential investor control issues, and so the operation of the separate account and the design of the matching rider must be consistent with the reasoning laid out in PLR 9433030, which addressed investor control for a dedicated separate account. Additionally the separate account must comply with the diversification requirements imposed by 1.817-5. Briefly, the issues are as follows:

Investor control could be a potential issue if every allocation decision by a participant led to a directly-corresponding change in the separate account assets. Aggregate tracking through the use of a passport basket exchange swap, so that no direct action by the separate account investment manager is required, will likely make this less of an issue, as will separating the tracking control from the ownership interest.

If the basket had only one mutual fund, then this product would look suspiciously like an end-run around the diversification requirements of 1.817-5. However, given a reasonable number of distinct assets in the basket, this is probably not a serious concern, and can be enforced by the rider terms. As noted above the market value of the passport basket exchange swap is likely to be less than 10% of assets, so that the separate account would be diversified for tax.

Drilling down to the next level of detail, we can make the following observations:

To the extent that the separate account has multiple divisions and all the divisions have much the same investment objectives and policy, a streamlined SEC registration procedure may be available;

Taking matching rider charges from the variable accounts would likely require exemptive relief similar to that obtained by Travelers for its S&P Index VA principal guarantee charge. Taking the charges from a general account bucket instead eliminates the need for this exemptive relief, and

Additional SEC and CFTC Issues

An entity writing passport basket exchange options would have to be either an investment company, a broker/dealer, or an exchange if it dealt directly with the public. The required status of a writer of passport basket exchange swaps is less clear. If the product were private placement instead of a registered VUL policy, then this presumably would not be an issue. If futures are used for hedging then the bona fide hedging exemption may protect the carrier from any requirement to register with the CFTC as either a Commodity Pool Operator or a Commodity Trading Advisor; alternatively, observing the quantitative restrictions under CFTC Rule 4.5 would be necessary. If hedging is done with individual stocks instead of futures, this is not an issue.

State Law Issues

Most states permit separate accounts to hold derivatives. Self-dealing is a different and more difficult issue: a separate account would likely require permission from the state insurance commissioner to hold derivatives written by an affiliate of the insurer. Likely alternatives are entering the passport basket exchange swap with an independent third party or development of a criss-cross structure between two carriers. Note that for reasonable correlations the market value of the passport basket exchange swap is likely to be less than 10% of separate account assets, so that it ought to be easy for the separate account to meet state diversification requirements.

Draft Rider—Notes and Form

The matching rider is intended to be used in conjunction with a registered VUL policy designed for the corporate market. Key features of the rider are as follows:

1) It is a general account rider, with charges taken from the fixed bucket of the VUL policy, and providing for a “top-up” style benefit. This reduces the likelihood that exemptive relief would be required from the SEC to offer the benefit.

2) The intent is for the matching benefit to be delivered primarily through the use of a dedicated separate account (one per client), so that the top-up comes into play rarely if ever. The dedicated separate account is referred to in the rider as the Designated Account. The separate account will hold an index fund and a passport basket exchange swap to provide the desired return.

3) The matching benefit applies only to balances at the beginning of a fiscal quarter and not to new money received during the quarter. This approach has the advantage of being simple, and will work very well if the nonqualified plan restricts deferral allocation alternatives to money market or S&P 500 Index allocations until the end of the quarter in which they are made.

4) A third party (the Index Administrator) has been defined as having the sole right to make changes to the custom index assets and weights. Ideally the Index Administrator would obtain participant allocations directly from an administrative system with no exercise of discretion by the client.

5) The rider contains limits on index composition to make it clear that no circumvention of VUL diversification requirements under the Internal Revenue Code is intended.

The draft text of the rider follows:

TOTAL RETURN INDEX RIDER

| General Provisions | Index Percentage. The Index Percentages on | |
|---|---|---|
| The Rider - This rider is part of the policy to | the Initial Reset Date are as selected by the | |
| which it is attached. The provisions of this | Index Administrator and shown on the Rider | |
| rider supplement, and where inconsistent | Specifications Page. Each Index Percentage | |
| override, corresponding provisions of the | is associated with a specific Index Asset. | |
| policy. Except where the rider provides | Opening Balance: The dollar value of the | |
| otherwise, it is subject to all provisions of the | Designated Account at the beginning of a | |
| policy. | Guarantee Period. | |
| The Rider Benefit - If no withdrawals, | Rider Charge: Initially, the amount shown on | |
| transfers, or loans are taken from the | the Rider Specifications Page. We declare a | |
| Designated Account during a Guarantee | new Rider Charge on each Reset Date. | |
| Period, we guarantee that the Total Return | Total Return for an Index Asset: the sum of | |
| for the Designated Account will at least | all investment returns over a given interval, | |
| equal the Total Return Index. We provide | including realized and unrealized capital | |
| this guarantee through our general account. | gains, return of principal, and coupon, | |
| Total Return Index Rider - Definitions | dividend, and interest payments, per dollar | |
| Designated Account: The Variable Account | invested in the Index Asset. | |
| for which we compute and guarantee a Total | Total Return for a Designated Account: the | |
| Return. On the Initial Reset Date, the | unit value for the Designated Account at the | |
| Designated Account is shown on the Rider | end of the Guarantee Period, divided by the | |
| Specifications Page. You may select a new | unit value for the Designated Account at the | |
| Designated Account on each Reset Date | beginning of the Guarantee Period, plus any | |
| from those that we then make available. | Total Return Index Credits divided by the | |
| Guarantee Period: A specific period of time | Opening Balance. | |
| for which we agree to provide the Rider | Total Return Index: An index that we | |
| Benefit described below for a specific Rider | compute for a Guarantee Period reflecting | |
| Charge. | the total return of each Index Asset weighted | |
| Index Administrator: The person with the | by the corresponding Index Percentage. | |
| sole right to select Index Assets and Index | Total Return Index Rider - Provisions | |
| Percentages and to request index | Rider Charge - The charge for this rider is an | |
| maintenance. The Index Administrator is | annual percentage of the value of the | |
| shown on the Rider Specifications Page. | Designated Account, as shown on the Rider | |
| Index Asset: An asset included in the Total | Specifications Page. The daily compounded | |
| Return Index computation. The Index Assets | equivalent of this charge is deducted daily | |
| on the Initial Reset Date are as selected by | pro-rata from each Fixed Option. | |
| the Index Administrator and shown on the | Other Policy Charges - While this Rider is in | |
| Rider Specifications Page. | effect policy charges are taken pro-rata from | |
| each policy account other than the | the Total Return for each Index Asset over | |
| Designated Account. | the Guarantee Period, summed. | |
| Reset Dates And Guarantee Periods - The | If index maintenance is requested, then the | |
| Initial Reset Date is the beginning of the first | Total Return Index is calculated separately | |
| Guarantee Period. The last day of the | for each period between requests as | |
| Guarantee Period is the expiration date for | described above. The results are then | |
| that Guarantee Period. Each subsequent | multiplied together to compute the Total | |
| Reset Date is the first day following the | Return Index for the entire Guarantee | |
| expiration date of a previous Guarantee | Period. | |
| Period and starts a new Guarantee Period. | Total Return Index Credit - At the end of | |
| At the expiration of a Guarantee Period we | each Guarantee Period we calculate a) and | |
| will send both you and the Index | b), where: | |
| Administrator a notice describing the then | a) | is the Total Return Index at the end of |
| currently available Guarantee Periods and | | the Guarantee Period divided by the |
| accounts that are available for you to select | | Total Return Index at the beginning of |
| as Designated Accounts, Index Assets, and | | the Guarantee Period; and |
| corresponding Rider Charges. | b) | is the unit value for the Designated |
| We reserve the right at any time to offer | | Account at the end of the Guarantee |
| Guarantee Periods, Index Assets, and Rider | | Period divided by the unit value for the |
| Charges that differ from those available | | Designated Account at the beginning of |
| when your policy was issued. | | the Guarantee Period. |

| | |
|---|---|
| Index Maintenance - The Index | If a) exceeds b) then we calculate the Total |
| Administrator may make one or more written | Return Index Credit as the Opening Balance |
| requests for index maintenance during a | times the quantity a) minus b). If b) exceeds |
| Guarantee Period. The Index Administrator | a) then the Total Return Index Credit is zero. |
| may select Index Assets from those we then | We then credit the Total Return Index |
| offer and specify Index Percentages subject | Credit, if any, to the Designated Account. |
| to the following rules: | Death Benefit - In calculating the Death |
| Each Index Percentage is less than 55%; | Benefit, we will treat the Date of Death as |
| The sum of any two Index Percentages is | the Reset Date and calculate a Total Return |
| less than 70%; | Index Credit The Fixed Option will then |
| The sum of any three Index Percentages | include any Total Return Index Credit |
| is less than 80%; and | payable. |
| The sum of any four Index Percentages is | Designated Account Transfers - If you |
| less than 90%. | transfer, withdraw, or borrow Accumulated |
| Total Return Index Calculation - If no index | Value from the Designated Account during |
| maintenance is requested during a Guarantee | the Guarantee Period then the Total Return |
| Period, then the Total Return Index is | Index Credit, if any, computed at the end of |
| calculated as each Index Percentage, times | the Guarantee Period will be reduced. The |
| the Total Return Index Credit by the ratio (a − | reduction will be performed by multiplying |
| b)/a, where: | |

| | |
|---|---|
| a) | is the number of units held by the policy |
| | in the Designated Account at the |
| | beginning of the Guarantee Period, and |
| b) | is the total number of units transferred, |
| | withdrawn, or borrowed from the |
| | Designated Account during the |
| | Guarantee Period, but not greater than |
| | a). |

Termination - This rider terminates
automatically when the policy to which it is
attached is surrendered, or at the death of
the Insured if the policy is still in force. You
may also terminate this rider on any Reset
Date.
Signed for the Quality Life Insurance
Company
Date:
Signature:

RIDER SPECIFICATIONS PAGE

| | |
|---|---|
| Rider Charge: | [0.60% per policy year] |
| Designated Account: | [Quality Life Variable Index Account #123] |
| Initial Reset Date: | [Dec. 31, 2001] |
| Guarantee Period: | [90 days] |
| Index Administrator | [Index Administrators, LLC] |
| Index Assets and Index Percentages: | |
| [T. Rowe Price Value Fund] | [20%] |
| [Putnam Voyager Fund Class Y] | [20%] |
| [Frank Russell U.S. Small Cap E] | [20%] |
| [Putnam Investors Fund] | [20%] |
| [Barclays Extended Equity Market] | [20%] |

Software Objective

The software objective is a realistic stochastic simulation model of hedging operations of a writer of passport basket exchange swaps. Key components of the simulation model are written so that they can also be used in the operational hedging system.

Background on Paired Passport Basket Exchange Options (=Passport Basket Exchange Swaps)

The mathematical setup for a passport basket exchange option is similar to the one for a passport option—an optimal stochastic control problem is to be formulated and solved. However, since the overall objective is for separate account performance to match the performance of the specified asset basket, the passport basket exchange options are always paired.

In detail, the separate account buys an option permitting it to exchange index performance for specified basket performance if basket performance is better, and sells an option permitting the counterparty to exchange basket performance for index performance if index performance is better. Clearly only one option will be exercised at the end of the quarter.

The hedging is much simpler for the pair of options than it would be for either option separately, because the optimal stochastic control problem is reduced to a tracking problem. Because the options are always paired, we can refer to a Passport Basket Exchange Swap.

Assumptions re Basket Assets

We assume domestic equity mutual funds are the primary asset in basket, with smaller amounts of international equity, balanced, and fixed income funds, and some employer stock. It is unlikely that funds with substantial holdings of private placement securities or swaps will be dealt with in the first phase.

Basket assets will be required to be diversified as under 1.817-5 to avoid unnecessarily raising IRS concerns that the product might be used to avoid the intent of the diversification rules.

Assumptions re Hedging Instruments

It is assumed that futures, exchange-traded funds, individual stocks, and mutual fund shares are the only hedging instruments available, and that items earlier in the list are preferred to items later in the list for reasons of liquidity and expense. Exchange-traded funds (ETF's) are assumed to include SPDR's, sector SPDR's, and Qubes.

Mutual fund shares per se are last in order of preference because they raise potential investor control and diversification issues, because they have higher expense fees than other investments, because they can only be traded daily, and because they cannot be shorted. However, in some cases (such as an international fund with an investment mix not close to any published benchmark) there is likely no better hedge for the fund holding than the fund itself.

Incremental Hedge Engine—Requirements

Determining the appropriate asset mix to hedge the passport basket exchange swap can be modeled mathematically as a linear regression problem. The predictor variables are the prices of the hedging instruments and the response variables are the prices of the assets in the basket.

For example, if the response variables are mutual fund share prices, mutual funds invest only in stocks, and the predictor variables include the entire universe of available stocks, then the response variables will be linear functions of the predictor variables.

This is a generalization of the tracking problem typically facing an index fund manager, i.e., how to construct a portfolio tracking, e.g, the S&P 500 Index without having to take a position in each of the 500 stocks comprising the index.

Although there are many software packages, such as SAS, that can be used to perform regression analysis, there are substantial difficulties in applying standard methods to this problem, for the following reasons:

Data Volume

Incremental Solution

Collinearity/Condition Number

Multiple Response Variables

Each of these difficulties is discussed in turn.

Data Volume

Each data row (i.e. vector of hedging instrument prices and mutual fund prices) is referred to as an observation. The number of observations could be very large if, for example, hourly (or more frequent) asset prices were being used to monitor whether adjustments to hedge positions were required. The data volume could therefore be very large, and so any approach that requires all the data to be simultaneously accessible will likely be slow.

Incremental Solution

The relationship between the predictor and response variables will change over time as fund managers change their holdings. It therefore makes sense, rather than attempting to calculate regression coefficients “once and for all”, to be able to update them based on incoming financial market information. Incremental solution is also important to provide the ability to perform multiple position updates during the trading day. A method requiring an overnight run, for example, is going to be of limited usefulness.

Standard packages, which read the entire dataset and then calculate a solution, will therefore be difficult to use.

Collinearity/Condition Number

Any approach that starts with “invert the X′X matrix” is doomed to failure for two different reasons: forming the X′X matrix roughly squares the condition number of the problem, and the matrix will in general be close to singular. Near-singularity will occur if there is any redundancy in the hedging instruments, e.g. if the set of predictor variables includes SPDR's and all the Sector SPDR's. Since real-life share prices are rounded to the nearest penny, the matrix will likely be ill-conditioned rather than exactly singular.

An ill-conditioned X′X matrix will lead to parameter estimates (and hence hedge positions) with terms opposite in sign and almost equal in absolute value: this is undesirable. It will also lead to unstable parameter estimates, which in hedging terms means making large position changes as updated asset prices come in: this is also undesirable.

Multiple Response Variables

Ideally we want a way to determine hedge positions quickly for arbitrary asset mixes. The mixes will in general change as a result of participant allocation activity even in the absence of trading activity by mutual fund managers.

Incremental Hedge Engine—Two Almost-Solutions

A popular way of computing continually-updated parameter estimates is the so-called recursive least-squares estimator. This is described in (for example) Optimal Control and Estimation by Robert F. Stengel. This method is difficult to apply in this case because it requires a matrix inversion to get the initial parameter estimate and so will not work if the matrix is rank-deficient.

A popular way of dealing with collinearity and conditioning problems in linear regression is to use the Singular Value Decomposition (SVD) of a matrix. A=UWV′ where U and V have orthonormal columns and W is diagonal. If A is rank deficient then zeros appear on the diagonal of W. A description of the SVD can be found in standard sources such as Numerical Recipes in C.

The big problem with using SVD is that there is no known way to update the SVD efficiently for incoming data rows, so that the method is not suited to the development of an incremental solution. This vastly increases the processing requirements.

Incremental Hedge Engine—Solution

An updateable matrix decomposition sharing many of SVD's good characteristics is the rank-revealing URV decomposition.

This matrix decomposition was introduced by G. W. Stewart in “An Updating Algorithm for Subspace Tracking” (IEEE Transactions on Signal Processing, Vol. 40, No. 6, June 1992) for phased-array radar applications. However, it turns out that it can be adapted to linear regression problems, and that the resulting algorithms are an excellent fit for this problem for the following reasons:

The decomposition is A=URV′ where U and V are orthogonal and R is right-triangular. Rank deficiency can be detected easily because the determinant of R is just the product of its diagonal elements.

The method uses only Givens rotations, which are orthogonal transformations, so the problem is as well-conditioned as possible.

The method allows efficient determination of the condition number of the problem (since efficient condition number estimators for triangular matrices exist).

Memory usage for the method depends only on the number of predictor and response variables, not on the number of observations. This can be viewed as a very specialized data compression algorithm.

The method allows for efficient determination of hedging parameters and standard errors.

The method allows for solution of any linear combination of predictor variables (hence easy aggregation to client and portfolio levels).

A variant of stepwise regression, bringing in hedging instruments (=predictor variables) one at a time, picking the one that increases R-squared the most, will tend to avoid picking linearly dependent columns. A condition number estimator for R can be used to verify that the results are meaningful. Using the Akaike Information Criterion to limit the number of variables in the model appears to be a workable automated approach, but will require additional testing.

Using the Incremental Hedge Engine

The Incremental Hedge Engine has three main uses:

a) As a custom data compressor, reducing historical data to its correlation structure;

b) As a simulation generator, allowing scenario generation based on the most up-to-date financial market data; and

c) As a hedge asset calculator, determining what combination of hedging assets are required to best approximate the asset basket

Dealing with Style Drift

Suppose that periodically (once per quarter or once every six months) the precise hedging coefficients for a particular fund are known, because its precise asset holdings are published. Suppose that at other times the only available information for the fund is daily NAV data.

This situation can be incorporated into the above regression framework by, periodically running the precise hedging coefficients through R and V to get what U′b would have had to have been to have yielded that as the answer to the regression problem, and then updating the response U′b for the fund accordingly

Hedging Simulation—Other Key Components

Scenario Generator

This generates a large number of correlated lognormal stock price scenarios, combines them to get index scenarios, and combines them to get mutual fund share price scenarios.

Fund Trade Generator

This component currently makes random stock trades subject to a constraint on the total number of stock positions that can be held by the fund

Participant Trade Generator

This component currently makes random fund trades subject to a constraint on the total number of fund positions that can be held by a participant

Summary of Proposed RBC and Valuation Basis

Deferred Compensation Asset Tracking (DCAT) is a product for the deferred compensation market. The product allows client companies to use Variable Universal Life (VUL) policies with customized basket exchange swaps to track the investment performance of a specified basket of assets. The basket of assets will typically represent aggregate participant balances in a nonqualified deferred compensation plan.

This patent describes a valuation and risk-based capital (RBC) basis for a VUL or other investment product using a customized basket exchange swap.

We describe California in detail because it already has an appropriate insurance regulatory framework in place. However, the generic NAIC (National Association of Insurance Commissioners) situation is also examined since it will have an impact on the ease or difficulty of getting state approvals for insurance products.

The primary sources for this analysis are a number of sections of the California Insurance Code (CIC), Bulletin 95-8 of the California Department of Insurance (the “Department”), the NAIC RBC instructions, and the June 2001 report of the American Academy of Actuaries Variable Annuity Guaranteed Living Benefit Working Group.

The flow of the analysis is from specific to general This reflects the fact that California has more detailed precedents than most other states, but that those other states will also have to be convinced that the proposed basis is appropriate.

The main conclusions for a VUL version of DCAT are that:

an RBC factor of 0.3% of assets may be appropriate, depending on the composition of the assets backing the DCAT benefit;

the basic reserve for a VUL policy with an attached DCAT rider should be a CRVM reserve; and

if hedging for the DCAT benefit is being performed by the carrier, then any additional reserve for the DCAT benefit should be a gross premium reserve equal to a specified percentile of the assumed loss distribution, consistent with the approach outlined by the AAA VAGLB Working Group.

CIC Sections 10507-10507.4 and 10203.10

These sections deal with investment return assurance and group investment return assurance, respectively. Both of these types of insurance, as defined:

Insure against a loss in value of mutual fund shares; and

Provide a benefit equal to the difference between the amount paid for the mutual fund shares and their value at the earlier of (1) the end of the policy period, or (2) the death of the insured.

It seems clear that the DCAT benefit, which does not provide a guarantee of principal, is substantially different from the benefit provided by investment return assurance. It is also the case that assets other than investment company securities may be included in the DCAT benefit, although this may not be the case for the initial version of the product.

It therefore seems very probable that these code sections are inapplicable.

CIC Section 10506.4

This section deals with separate accounts with a general account guarantee. Three different types of guaranteed separate account products are described in 10506.4(b)(1), (2), and (3). The first two types provide for a guarantee of principal: the third is the closest fit to DCAT. Subsection 10506.4(b)(3) is too long to include in its entirety but the key points are as follows:

The guarantees contained in the policy must be based upon a publicly available interest rate series or an index of the aggregate market value of a group of publicly traded financial instruments;

The duration of the guarantee must not exceed five years (the actual language is more obscure, but this is a reasonable interpretation of how it might apply to DCAT); and

Withdrawals before the end of the guarantee must be at no greater than market value.

Note that the language of the first bullet point is broad enough to encompass DCAT.

Department Bulletin 95-8 sets out requirements for carriers wishing to issue contracts under this section. Carriers must provide, among other things:

information on policy forms, personnel, and the method of operation of the separate account, including a description of any hedging techniques;

a description of the reserve and asset valuation methodology for the product;

for contracts under 10506.4(b)(3) (e.g. DCAT) a demonstration that the investment strategy is likely to match the performance of the index;

a copy of any prospectus filed with the SEC; and

an actuarial memorandum demonstrating that the pricing of any general account guarantees is reasonable and sufficient.

These are all things that a carrier presumably would like to have in place in any case.

For contracts under 10506.4(b)(3) (e.g. DCAT) the Bulletin states that the basic reserve is the account value defined in the contract, which is usually (emphasis added) the market value of assets in the separate account. Since this was almost certainly written with group annuities rather than VUL in mind, it seems likely that a CRVM reserve would be a more appropriate basic reserve in this case.

CIC Section 10506.5

This section of the California Insurance Code deals with guaranteed living benefits provided by variable contracts.

The definition of guaranteed living benefits at first seems broad enough to capture DCAT, since it includes variable life and doesn't mention a guarantee of principal:

For the purposes of this section, “guaranteed living benefit” means a benefit in a variable annuity or variable life insurance contract providing that one or more benefit amounts available to a living contractholder, under specified conditions, will be enhanced should it fall below a given level, in the absence of the guaranteed living benefit.

However, the last paragraph of the section says, in part:

No policy, contract, rider, or agreement that constitutes investment return assurance pursuant to Section 10203.10 or 10507, or guarantee pursuant to Section 10506.4, may be issued pursuant to this section.

What determines which section governs DCAT? For 10203.10 and 10507, the distinctions drawn above should be sufficient to show that they are not applicable. Drawing the line between 10506.4 and 10506.5 is based on a size criterion, i.e. $1 million in premium from an accredited investor vs. a retail sale. This follows from the statute language, since the preamble in 10506 refers to pension, retirement, and profit-sharing plans (without mentioning ERISA) and since 10506.4(h) requires the contract owner to be an accredited investor under Regulation D of the 1933 Act and that the premium volume be $1 million in aggregate (with a weaker condition for startup plans).

If DCAT is used in conjunction with an existing registered VUL product, and 10506.4 classification is desired, then the (somewhat unusual) outcome would be a registered product that would only be sold to accredited investors.

NAIC RBC Instructions

Examining the NAIC RBC instructions has three purposes:

Helping to set the RBC level for the guaranteed separate account, since the California Insurance Code does not address this issue;

Providing some indication as to how states without California's detailed regulatory framework will interpret DCAT for RBC and valuation purposes; and

Providing some insight into how counterparties subject to a value-at-risk (VAR) calculation might want to set capital requirements for a passport basket exchange swap.

The instructions describe how to set C-1 and C-3 factors for guaranteed separate accounts based on the underlying assumption that there are exactly two types of accounts. Since DCAT does not exactly fit this assumption, some interpretation is required. An excerpt from the RBC instructions will be helpful in understanding the situation:

Guaranteed separate accounts are divided into two categories: indexed and non-indexed.

Indexed separate accounts are invested to mirror an established securities index that is the basis of the guarantee. Consequently, indexed separate accounts are relatively low risk; the risk-based capital factor is the same as class 1 bonds. Non-indexed separate accounts with guarantees are subject to the risk of the underlying assets, therefore 100 percent of the calculated risk-based capital of these accounts is appropriate. Contracts reserved at book value are reported for the RBC calculation exactly as if they were General Account funded.

For contracts valued using the market value of assets and the fair value (at current interest rates) of liabilities, risk-based capital is calculated as the excess of the regular C-1 and C-3 standards over the applicable reserve margins. New York Regulation 128 and California CIC 10506 are two examples of state valuation laws regulating such business. The reserve margin is calculated as the excess of the statement value of the assets supporting the reserve (including any supplemental general account reserves) over the present value of the guaranteed payments. The present value of guaranteed payments is calculated using the expected net portfolio rate of return, and is not to exceed 105 percent of U.S. Treasury spot rates. The excess, if any, of the asset value over the present value of guaranteed payments is first applied to reduce the C-3 requirement. The remainder is used to reduce the C-1 requirement. The risk-based capital amount to be entered in the worksheet is the C-1 and C-3 requirements for these contracts after these credits. Excess margins may not be applied to contracts for which these amounts are not available.

The last paragraph describes a subset of nonindexed separate accounts. It appears to be incomplete, because as described above, CIC 10506 is broader in scope than it implies, covering indexed contracts.

Clearly, DCAT provides no principal guarantee, so there is no obvious rationale for applying general account C-1 and C-3 factors, which assume the existence of such a guarantee. The indexed separate account alternative seems more appropriate but requires some additional analysis from three perspectives:

The fit with the descriptive language;

Appropriateness if a passport basket exchange swap supports the product, i.e. whether the factor makes sense if the carrier takes only credit risk; and

Appropriateness if the carrier performs the hedging operations in-house, i.e. the carrier takes the hedging risk.

Each of these facets is analyzed in more detail in the following sections.

Fit with Descriptive Language

DCAT does not provide indexing to an established securities index, but a reasonable reading of 10506.4(b)(3) is that the statutory requirement is only that the reference be to an index of publicly-traded securities. It is also certainly true that the strategy for hedging the benefit is to invest to mirror the index that is the basis of the guarantee. On balance, it can probably be concluded that the class 1 bond RBC factor (0.3%) is appropriate.

Passport Basket Exchange Swap

If a passport basket exchange swap is in place with the appropriate counterparty, then the carrier assumes no hedging risk, but rather the risk that the counterparty may default. Default on the swap would not lead to loss of all the assets in the separate account, just to a loss of the potential top-up. A reasonably conservative assumption for the size of the top-up might be 2.5% per quarter, as described in the next section. If the counterparty is in any of the top three NAIC rating classes (RBC factors of 0.3%, 1%, and 4% respectively), we can then conclude (by multiplying the magnitude of the top-up by the RBC factor for each of the three classes) that the class 1 bond RBC factor (0.3%) is more than sufficient.

In-House Hedging

The NAIC RBC factors have generally been set to be adequate, in aggregate, at the 95^{th} percentile of some assumed loss distribution over a two- or three-year period. This can be approximated as “two standard deviations” since a normal distribution is a popular assumed distribution for working purposes.

Assume that a carrier hedges the DCAT product in-house, that it can achieve a correlation of 99.5% between the hedging instruments and the participant notional asset mix, and only writes one case. This last assumption is obviously extreme.

Two standard deviations is about five times the exchange option cost. For a correlation (R-squared) of 99.5% and a volatility of 25%, this leads to an assumed loss at the two standard deviation level of approximately 2.5% per quarter. Over two years (eight quarters) this leads to an assumed loss of 7.07%- considerably more than the factor-based approach would indicate. Deducting expected rider revenue over the two year period does not alter the conclusion substantially.

However, the RBC factor for DCAT is qualitatively different from all the existing ones (perhaps it should be dubbed “C-5”?), so that logically it should be a separate squared piece of the covariance calculation, leading to additional capital requirements similar to that arising from the factor basis. Specifically, the correlation risk posed by DCAT is neither mortality nor asset default risk.

The incremental capital requirement for DCAT could then be the same order of magnitude as the risk factor for class 1 or 2 bonds. For example, assume that a carrier has written $1 billion of fixed annuities (with combined C-1 and C-3 of 2.0%) and then writes $100 million of DCAT (with C-5 of 7.1%- admittedly extreme). The capital requirement before DCAT is 2% * $1 billion =$20 million; after writing DCAT we have required capital of (C-1²+C-5²)^{1/2}=$21.2 million, corresponding to an incremental factor of 1.2%, close to the risk factor for class 2 bonds.

Clearly a company writing only DCAT business, and hedging it all in-house, could end up with high capital requirements under this approach if they were tracking only a few different notional assets. As the number of notional assets increases, the analysis indicates that the R-squared will approach one, decreasing capital requirements.

Conclusion on Proposed RBC Basis

A reasonable conclusion is to set the C-1 factor to 0.3% and the C-3 factor to zero.

AAA VAGLB Working Group Report and Draft Guideline MMMM

The treatment that would follow from the AAA VAGLB Working Group Report and Draft Guideline MMMM is relevant because states other than California may be tempted to classify DCAT as a guaranteed living benefit.

The report and guideline deal with a stochastic reserve method for guaranteed living benefits, assumed to be annuity benefits provided under fixed-rate secondary guarantees.

Some key distinctions between DCAT and VAGLB'S are as follows:

The report and guideline assume that benefits are being offered on an unhedged basis, which will likely not be the case for DCAT;

The report and guideline assume that the benefits are being offered for a guaranteed charge with little or no ability for the carrier to reset premiums under changing market conditions, which will not be the case for DCAT;

DCAT costs do not depend strongly on whether risk-neutral or historical drifts are assumed, being much more sensitive to volatility and correlation;

Scenario testing and exchange-option pricing are the most appropriate methods for determining reserves for the DCAT benefit, while the Keel method is not appropriate;

The absence of correlations for different asset classes in the VAGLB work to date implies that none of the scenario generation approaches outlined by the Working Group will be appropriate without modification;

The distribution of DCAT costs in the in-house hedging case is much more symmetrical than the distribution of GMAB costs The concern that the reserve may be zero at the 83⅓ percentile while having a positive expected value is not applicable, and a lower percentile may be appropriate;

If the pricing basis for DCAT is such that the excess of carrier revenues over costs is expected to be positive 83⅓% of the time, then “VAGLB-like” reserves for DCAT will be zero; and

If the Academy proceeds to develop RBC C-3 Equity requirements to complement the VAGLB reserve requirements, it might be worthwhile to make a submission formalizing the C-5 argument outlined above.

In summary, it seems to be possible to fit DCAT into an extension of the VAGLB Working Group methodology if required, although the extensive list of differences implies that substantial modifications to the basic approach will be required.

Introduction to Simulation Model and Initial Results

Deferred Compensation Asset Tracking (DCAT) is a product currently under development for the deferred compensation market. The product will allow client companies to use VUL policies to track the investment performance of a specified basket of assets. The basket of assets will typically represent aggregate participant balances in a nonqualified deferred compensation plan.

The simulation model for DCAT has three objectives

To demonstrate how to hedge the returns of baskets of mutual funds using a mix of hedging assets, such as S&P 500 futures and Select Sector SPDR's, given some simplifying assumptions;

To demonstrate that making the assumptions more realistic leads to approximately the same results; and

To develop a simplified pricing basis for the product, i.e. a method for developing an approximate price for the product which does not require extensive stochastic simulation.

Hedging Assets

Starting Assumptions

The key starting assumptions are that:

mutual fund asset holdings are transparent, i.e. that a full list of fund holdings is available every quarter; and

the only hedging assets available are ones that hedge sectors, i.e. ones that are analogous to Sector SPDR's, not individual stocks.

These simple assumptions allow us to get an estimate of the DCAT benefit cost.

Note in particular that in the actual implementation the range of hedging instruments would almost certainly be broader, and include S&P 500 index futures, Nasdaq 100 futures, individual stocks, and mutual funds.

What are Sector SPDR's?

To paraphrase the Select Sector SPDR Prospectus, (available for download at http://www.amex.com) the Sector SPDR Trust consists of nine separate funds, each with the investment objective of providing investment results that, before expenses, correspond to the price and yield performance of the publicly traded equity securities in each Sector Index. Each of the 500 companies in the S&P 500 Index is represented in exactly one of the Sector Indices, and no other companies are represented.

Historical SPDR Data

We have compiled historical price data for SPDR's and Sector SPDR's. Even without attempting to adjust for fund distributions and expense differences, the correlation (R² for a best-fit multivariate linear regression) for SPDR closing prices vs. Sector SPDR closing prices is 99.6%. This high degree of price correlation occurs because the S&P 500 Index and the Select Sector Indices are both capitalization-weighted, as described in the next paragraph.

Each index is constructed as the number of shares outstanding times the closing price for each company, all summed and divided by a normalizing factor. Therefore the total change in the S&P 500 capitalization for a given day must equal the total change in the Sector Indices for the day. The normalizing factors are not discussed further other than to say that they are set so as to keep the index value instantaneously constant as companies are added, dropped, issue common shares, or buy back common shares.

Realized correlation will fall short of 100% because:

Sector SPDR closing prices in the secondary market may not exactly track net asset value (NAV) for the funds, although they will normally be close because of arbitrage considerations; and

the Sector SPDR trust may vary its holdings from the Select Sector index weightings or hold stocks that aren't in the Select Sector index while pursuing its objective of tracking the index accurately.

Still, a correlation on the order of magnitude of 99.6% is sufficiently high to allow the DCAT benefit to be hedged, as described in more detail below.

Simplified DCAT Pricing Basis

The tracking error for the benefit provided by DCAT has a cost similar to that of an exchange option.

It is therefore the case that, in the absence of systematic hedging errors, the cumulative hedging error (or “tracking error”) for DCAT will follow a random walk, with the steps being proportional to the cost of an exchange option priced using the realized correlation (R²) of the hedging asset mix.

The expected cumulative hedging error will be approximately equal to the price of an exchange option, times the square root of the number of periods in the simulation, times a constant of proportionality. We can refer to this as “the simplified DCAT pricing basis”.

The simplified DCAT pricing basis can then be used in the following three-step approach to get a rough price for the benefit:

Develop a simple simulated world of stocks, funds, and sectors and observe the distribution of hedging financial results and R² for a given set of hedging instruments and varying behavioral assumptions for funds and nonqualified deferred compensation plan participants;

Gather historical data on mutual fund share prices and hedging instruments and see what R² could have been achieved using a given set of hedging instruments; and then

Infer the likely distribution of hedging financial results by using the R² from the results of the first two steps.

The simulation model described in the next section was used to test the simplified DCAT pricing basis against a more detailed stochastic simulation.

Model Structure and Assumptions

A quick summary of the model is as follows. It:

Has a pricing horizon of ten years;

Runs quarter-by-quarter for ten years (one scenario), and does this 100 times (100 scenarios);

Assumes 81 stocks divided into nine sectors of nine stocks each;

Assumes stock volatility is uniformly distributed between 30% and 40%;

Generates stock prices for individual stocks from a multivariate lognormal distribution, then weights them together (equally to start, then with random weights) to create the sector indices;

Assumes 75% correlation for stocks in the same sector, and 40% for stocks in different sectors;

Models twenty-four funds, each of which holds stocks selected at random (i.e. not biased towards a specific sector), with 15 stocks per fund initially, then 40; and

Models 625 plan participants, each of whom invests in five funds at random.

The numbers of stocks, funds, and participants could easily be increased if required.

Calculating Hedging Parameters

The Incremental Hedge Engine maintains data structures so that regression coefficients and R² (measure of correlation) can be computed efficiently for any linear combination of stock prices at each epoch (“tick”) of the model. A brief description of the underlying algorithms is given above.

Assuming that the holdings of each fund and each participant are known, the stock weightings implied by the participant choices are fully determined at each tick in the model. Clearly if each stock could be traded without cost at each tick, there would be no tracking error under these assumptions. However, this assumption implies an unrealistic amount of stock trading. Instead, we use linear regression with the response variable being the linear combination of stock prices and the predictor variables (hedging instruments) being sector indices. This corresponds to trading Sector SPDR's instead of individual stocks. There is, of course, tracking error, because the stocks within a sector are not perfectly correlated.

Model Results with Varying R²

The model was run with common random numbers and differing fund and participant behavioral assumptions to test the simplified DCAT pricing basis, i.e. the hypothesis that the standard deviation of the present value of the tracking error would be proportional to the price of an exchange option (times the square root of 40, the number of quarters per simulation run).

| Run # | Realized R² | Realized σ | SD[PVCost] | Exch Option | Ratio |
|---|---|---|---|---|---|
| 1 | 0.996189 | 0.230767 | 0.0691 | 0.0254 | 2.72 |
| 2 | 0.999985 | 0.230767 | 0.0041 | 0.0016 | 2.56 |
| 3 | 0.999985 | 0.230767 | 0.0041 | 0.0016 | 2.56 |
| 4 | 0.999941 | 0.230767 | 0.0083 | 0.0032 | 2.59 |
| 5 | 0.999938 | 0.230767 | 0.0081 | 0.0032 | 2.53 |
| 6 | 0.997806 | 0.230767 | 0.0486 | 0.0193 | 2.52 |
| 7 | 0.998912 | 0.230767 | 0.0322 | 0.0136 | 2.37 |

The ratio of standard deviation (tracking error) to exchange option cost is fairly stable. The runs were as follows:

Run 1—Only 15 stocks per fund, assumptions as described above;

Run 2—Each fund holds uniformly distributed 100-200% weightings of each stock, normalized to 100% in total, trading each quarter;

Run 3—100-200% of each stock, normalized, frozen after first quarter's trades;

Run 4—100-500% of each stock, normalized, trading each quarter,

Run 5—100-500% of each stock, normalized, frozen after first quarter;

Run 6—Using 40 stocks per fund instead of 15, random weights for each stock held in the fund, trading each quarter; and

Run 7—Using 40 stocks per fund instead of 15, random weights for each stock held in the fund, frozen after first quarter.

We can attempt to estimate the constant of proportionality in the random walk by simulating returns from correlated lognormal distributions and calculating the ratio of the standard deviation of results to the exchange option price for different volatilities and correlations. The results are instructive, and are shown below for a term of three months based on 10,000 simulations:

| | Corr | | | |
|---|---|---|---|---|
| Vol\ | 0.95 | 0.97 | 0.99 | 0.995 |
| 0.15 | 2.49 | 2.49 | 2.49 | 2.49 |
| 0.20 | 2.50 | 2.50 | 2.50 | 2.50 |
| 0.25 | 2.50 | 2.50 | 2.50 | 2.50 |
| 0.30 | 2.51 | 2.51 | 2.51 | 2.51 |

The ratio is close to a constant 2.5, which is fairly consistent with the results in the previous section.

Unequal Index Weights

If Run 6 above is modified so that the stocks in each of the nine indices are weighted randomly (uniform distribution, normalized) instead of equally, the resulting R² is 0.995878, the realized sigma of 0.22769, the standard deviation of the present value of tracking error is 0.0558, and the exchange option cost of 0.0261. The ratio is now 0.0558/0.0261=2.14, further from the 2.5 ratio in the previous section than Run 6 was, but still reasonably close.

The likely reason for the change in the constant of proportionality is that the resulting distribution of returns for each sector is further from lognormal. Note that on this method, the aggregate choice of the plan participants does not tend in the limit to the indices, which is not completely realistic.

Applying the Simplified Pricing Basis

The simplified pricing basis can now be applied, using an approach consistent with the AAA VAGLB stochastic reserving methodology.

In this approach, the rider charge should be set so that, together with fee difference between institutional-level mutual fund pricing and SPDR pricing (e.g. 65 bp−30 bp=35 bp), the charge will cover expenses and cover the expected loss distribution at the 83⅓% percentile, i e. approximately 1 standard deviation.

So, for example, assuming:

an annual rider charge of 60 bp;

an annual fund fee difference of 65 bp−30 bp=35 bp;

an annual asset trail cost of 20 bp; and

incremental annual investment management expense of 20 bp;

then the annual net risk charge flowing to the carrier's general account is 55 bp. In this case the results above for unequal index weights in the previous section, with R2 of 99.59%, imply coverage of the loss distribution at approximately one standard deviation over a ten-year pricing horizon. If required capital is 0.3% RBC with a 200% assumed ratio (i.e. 60 bp), then the expected average annual pretax ROI over the pricing period will be 55 bp/60 bp=91.6%.

Product Repricing

The main reasons for repricing the product are changes in fee differences due to changes in the asset mix and changes in correlations. Relevant correlations include the correlation between the target assets and the available hedging instruments, and the realized correlation that the hedging strategy has been able to achieve.

It is important in repricing nonguaranteed products to be able to distinguish between retrospective and prospective elements. This is a particularly important issue in dealing with some state insurance departments, because repricing to recoup past losses is not permitted.

The recommended approach for this product is to include the expected correlation achieved by the hedging strategy as part of the pricing basis. If realized correlations have in general been lower than assumed in pricing, it is reasonable for the actuary to revise the best estimate of future realized correlations downward, and then future premiums for the rider will, all other things being equal, be higher.

DCAT Critical Mass

The critical mass for DCAT is the volume of business (either dollar volume or number of distinct mutual funds covered) required for the product to be economically viable. The critical mass for DCAT depends on the hedging strategy employed, as outlined in the following sections.

Critical Mass 1

“Critical Mass 1” could be defined as getting enough assets to set up a dedicated separate account—a dollar amount of say $5 million, depending on the hurdles for setting up separate accounts and the minimum purchase and sale sizes for institutionally-priced (Y share) mutual fund shares. At this level the hedging could actually be done by buying and selling mutual fund shares, although the carrier would likely not do the transaction themselves

The closest analogs of which we are aware are “clone funds” for the Canadian RRSP market. RRSP is short for Registered Retirement Savings Plan—similar to an IRA in the U.S. market.

Critical Mass 2

“Critical Mass 2” could be defined as getting enough different mutual funds with enough correlation to start hedging using futures, sector SPDR's, and stocks as well as the fund shares and hence pick up some extra margin, without knowing the exact stock holdings of each fund.

In the absence of more-detailed historical data, assume all funds are correlated 67.5% with the S&P 500 (i.e. their R-squareds are all 67.5%) and 45% with each other. Then the sample correlation for N funds is as follows:

| N | R² |
|---|---|
| 5 | 0.894838 |
| 10 | 0.945664 |
| 15 | 0.965026 |
| 20 | 0.974376 |
| 25 | 0.979403 |
| 30 | 0.984404 |
| 40 | 0.989532 |
| 50 | 0.991968 |
| 60 | 0.994417 |
| 70 | 0.995716 |

This table suggests that approximately 50 funds is critical mass for hedging without detailed information on fund compositions, if the funds are screened for an R² of 70% or greater and if investment decisions for the funds are independent. In the extreme case of 50 funds all run by the same stock-picker, this type of analysis clearly wouldn't work.

Note that detailed analysis of the stock holdings of each fund is not required, just knowledge of the R² of the funds.

Although cross-correlation data is not readily available, it is possible to get R² without too much difficulty. For a random selection of 200 large-cap finds (100 value, 100 growth), the average R² from Morningstar data was 68%, with 110 out of 200 funds having correlations at least equal to the mean. Notice that the very fact that the funds are in the value or growth categories means that they ought to have less than perfect correlation with the overall index.

So-called “large-cap blend” funds were analyzed separately since that's the category in which index funds are placed. After removing 15 obvious index finds from the initial list of 100 funds, the average R² of the remaining 85 finds was 86.19%, and 57 of the funds had correlations at least equal to the average.

Critical Mass 1. 5

“Critical Mass 1.5” could be defined as covering enough different mutual funds with enough correlation to start hedging using futures, sector SPDR's, and stocks as well as the fund shares and hence pick up some extra margin, with at least some information on the stock holdings of each fund.

Critical Mass 1.5 is between Critical Mass I and Critical Mass 2, with the exact position depending on the quality of portfolio data that can be obtained for the mutual funds and the frequency with which it can be obtained, as well as the rate at which the fund assets turn over.

What we claim is:

1. An article of manufacture comprising a customized basket exchange swap with a specified term, notional amount, reference index, and custom index operatively arranged to allow an index administrator designated by a counterparty to such customized basket exchange swap to specify a composition of said custom index at a start of said term and changes to said custom index during said term, while guaranteeing that a value of said customized basket exchange swap at an end of said term will equal said notional amount times the difference in the growth of said reference and custom indices.

2. The article of manufacture recited in claim 1 wherein said reference index is selected from the group consisting of equity index, bond index, commodity index, interest-rate index, volatility index, and currency index.

3. The article of manufacture recited in claim 1 wherein said reference index is derived from the return on a predetermined set of financial instruments.

4. The article of manufacture recited in claim 1 wherein said custom index is selected from the group consisting of equity index, bond index, commodity index, interest-rate index, volatility index, and currency index.

5. The article of manufacture recited in claim 1 wherein said custom index is derived from the return on a predetermined set of financial instruments.

6. The article of manufacture recited in claim 1 wherein said changes may be made only as mutually agreed by said counterparties at the time of said changes.

7. The article of manufacture recited in claim 1 wherein said changes may be made by said index administrator throughout said term of said customized basket exchange swap without requiring agreement by said counterparties at the time of said changes.

8. The article of manufacture recited in claim 1 wherein said changes may be made by said index administrator on a basis agreed upon by said counterparties and said index administrator at the beginning of said term of said customized basket exchange swap.

9. A computer-based method for efficiently determining an asset mix to hedge a customized basket exchange swap with a specified term, notional amount, reference index, and custom index, and an estimated tracking error for said asset mix, comprising the steps of:
updating a matrix factorization to reflect current financial market data;
calculating an objective vector based on current composition of said custom index;
determining a correlation coefficient and said asset mix from said matrix factorization and said objective vector; and,
calculating an estimated tracking error from said correlation coefficient

10. The computer-based method recited in claim 9 wherein said financial market data is observed only at the beginning of said term of said customized basket exchange swap.

11. The computer-based method recited in claim 9 wherein said financial market data is observed a plurality of times throughout said term of said customized basket exchange swap.

12. The computer-based method recited in claim 9 wherein said financial market data is observed substantially as often each day that said financial market data is published throughout said term of said customized basket exchange swap.

13. The computer-based method recited in claim 2 wherein trades to achieve said asset mix occur only at the beginning of said term of said customized basket exchange swap.

14. The computer-based method recited in claim 2 wherein trades to achieve said asset mix occur a plurality of times throughout said term of said customized basket exchange swap.

15. The computer-based method recited in claim 2 wherein trades to achieve said asset mix occur substantially as often each day that said financial market data is available throughout said term of said customized basket exchange swap.

16. A computer-based method for determining a price to charge for entering into a customized basket exchange swap, based on an estimated tracking error of an asset mix to hedge said customized basket exchange swap, and a capital requirement and a target rate of return for a counterparty to said customized basket exchange swap.

17. The computer-based method recited in claim 16 wherein said price is charged at the beginning of said term of said customized basket exchange swap.

18. The computer-based method recited in claim 16 wherein said price is charged at the end of said term of said customized basket exchange swap.

19. The computer-based method recited in claim 16 wherein said price is charged periodically throughout said term, and wherein said price is constant throughout said term.

20. The computer-based method recited in claim 16 wherein said price is charged periodically throughout said term of said customized basket exchange swap, and wherein said price may be reset throughout said term on a basis agreed by said counterparties at the beginning of said term.

21. The computer-based method recited in claim 16 wherein said price is charged periodically throughout the term of said customized basket exchange swap, and wherein said price may be reset at reset dates throughout said term on a basis agreed by said counterparties on said reset dates.
